(19) United States
(12) Patent Application Publication
(10) Pub. No.: US 2006/0154707 A1
(43) Pub. Date: Jul. 13, 2006

(54) Non-interfering wireless communication device fastener

(75) Inventors: Jonathan D. Friedman, Seattle, WA (US); Victor E. Shiff, Woodinville, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/193,102

(22) Filed: Jul. 29, 2005

Related U.S. Application Data
(60) Provisional application No. 60/641,964, filed on Jan. 7, 2005.

(51) Int. Cl. H04M 1/00

(52) U.S. Cl. 455/575.6

(57) ABSTRACT

A fastening system is disclosed for wireless communication devices that may be worn by a human being. The fastening system may employ a conductive material, for example, which may be used by the wireless communication device for receiving wireless signals, for example. Further, the conductive may be molded or embedded into a non-conductive (e.g., polyurethane) fastener for attaching the device to a human being, for example. The non-conductive fastener may include cleats that may protrude out from the fastener to protect the device's communication system. Further, metal links may be attached to the non-conductive fastener using traditional fastening hardware that may be used for the particular wireless communication device associated with the fastener.

### PRIORITY CLAIM

This application claims the benefit of U.S. Provisional Patent Application Ser. No. 60/641,964 filed on Jan. 7, 2005, which is incorporated by reference herein.

### TECHNICAL FIELD

The technology relates generally to wireless communication devices and, more particularly, to fastening systems that secure wireless communication devices to people or other living beings without interfering with the device's communication system.

### BACKGROUND

As society becomes more mobile, the use of wireless communication devices is growing rapidly because they can provide people with real time information. The increasingly miniaturized components being employed in these wireless communication devices have led to the development of wireless devices that may be worn on or otherwise attached to a person's body.

People's expectation of a wireless communication device's aesthetic appearance often changes when they wear these types of devices. They often want the worn devices to look like traditionally worn artifacts or otherwise have a nice, aesthetically pleasing appearance. The wireless communication environment these devices are designed to operate in, however, may often limit the types of materials used in their manufacture. Some materials may interfere with the reception and/or transmission of wireless signals and their use in these devices is therefore avoided.

### SUMMARY

The following section of this patent application document presents a simplified summary of the disclosed subject matter in a straightforward manner for readability purposes only. In particular, this section attempts expressing at least some of the general principles and concepts relating to the disclosed subject matter at a relatively high-level simply to impart a basic understanding upon the reader. Further, this summary does not provide an exhaustive or limiting overview nor identify key and/or critical elements of the disclosed subject matter. As such, this section does not delineate the scope of the ensuing claimed subject matter and therefore the scope should not be limited in any way by this summary.

A fastening system is disclosed that may be used to attach wireless communication devices to human beings, for example, using aesthetically pleasing materials (e.g., stainless steel) in a manner that does not interfere with the device's ability to receive wireless communication signals. In particular, the fastening system may employ one or more conductive materials for receiving wireless signals, which may be molded or embedded into one or more non-conductive (e.g., polyurethane) materials to form a fastener for attaching the device to a human being, for example.

Further, the fastener may include one or more non-conductive cleats that may protrude out or away from the fastener for coupling it to one or more conductive materials. Since the conductive materials coupled to the non-conductive cleats are basically shielded from the conductive materials that may be embedded within the non-conductive portion of the fastener, the embedded conductive material's ability to receive wireless signals may not be substantially deprecated.

Additionally, the one or more conductive materials that may be attached to the one or more cleats that may be formed in the non-conductive portion of the fastener may provide more options as far as the types of materials that may be used in such fastening systems for enhancing the aesthetic appearance of the devices in general, for example.

### BRIEF DESCRIPTION OF THE DRAWINGS

The ensuing detailed description section will be more readily appreciated and understood when read in conjunction with the accompanying drawings, wherein:

FIG. 1 is a diagram illustrating wireless communication devices;

FIG. 2 is a top view diagram of a fastening system that may be employed by one or more of the wireless communication devices shown in FIG. 1;

FIG. 3 is a top view diagram of a portion of the fastening system shown in FIG. 2 without an outer fastener covering attached to the device fastener;

FIG. 4 is a side view diagram of a portion of the outer fastener covering shown in FIG. 3; and

FIG. 5 is a cross-sectional view diagram of a portion of the fastener system shown in FIG. 2.

The same reference numerals and/or other reference designations employed throughout the accompanying drawings are used to identify identical components except as may be provided otherwise.

### DETAILED DESCRIPTION

The accompanying drawings and this detailed description provide exemplary implementations relating to the disclosed subject matter for ease of description and exemplary purposes only, and therefore do not represent the only forms for constructing and/or utilizing one or more components of the disclosed subject matter. Further, while this description sets forth one or more exemplary operations that may be implemented as one or more sequence(s) of steps expressed in one or more flowcharts, the same or equivalent operations and/or sequences of operations may be implemented in other ways.

As mentioned above earlier, the wireless communication environment in which wireless communication devices are designed to operate in may often limit the types of materials that may be used in their manufacture. Again, some materials may interfere with the reception and/or transmission of wireless signals and their use in these devices is therefore avoided. However, the fastening system disclosed herein attempts to provide at least one solution that may provide greater flexibility in enabling a greater variety of materials to be used in manufacturing these types of devices and may potentially lead to improving the aesthetic appearance of these devices as well.

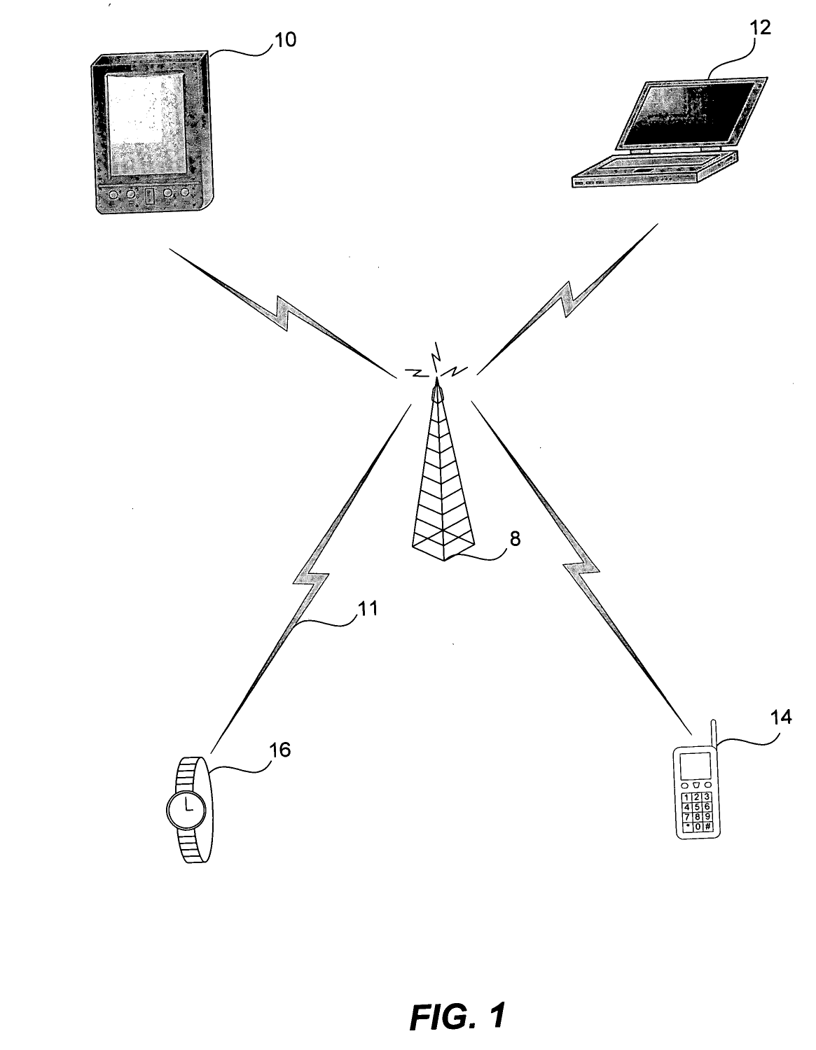

Generally, a mobile wireless device may comprise an electronic device having a wireless communication system, such as an antenna system, configured to receive and/or transmit communication signals, such as high, very-high, and/or ultra-high frequency signals, to/from a transmitter or a transceiver. An example of a transceiver 8 is also shown in FIG. 1. Further, the communication system in each device may employ a wireless interface, such as an FM transmission system. As illustrated in FIG. 1, an FM signal or broadcast is transmitted over a communication channel 11 to various electronic devices shown in FIG. 1 with an FM receiver or transceiver, although other types of receivers or transceivers using other signals may be used.

The electronic devices are arranged to receive information from the signal or broadcast. The broadcast may be of any number of types, such as a standard FM transmission, a sub-carrier FM transmission, or any other type of FM transmission as may be desired. The operating environment shown and described with reference to FIG. 1 is only an example of one of potentially many other suitable operating environments, and is not intended to suggest any limitation as to the scope of use or functionality of the invention.

Referring more specifically to FIG. 1, the examples of the mobile wireless devices include a PDA 10, laptop computer 12, cellular phone 14 and a smart watch 16, although other types of wireless devices that may or may not be worn by a person may include microphones, earphones, and the like. A smart watch 16 may comprise a watch that may be worn by a person and which may have a processing system for processing data encoded in communication signals 11 sent from an FM transceiver received via the watch's communication system.

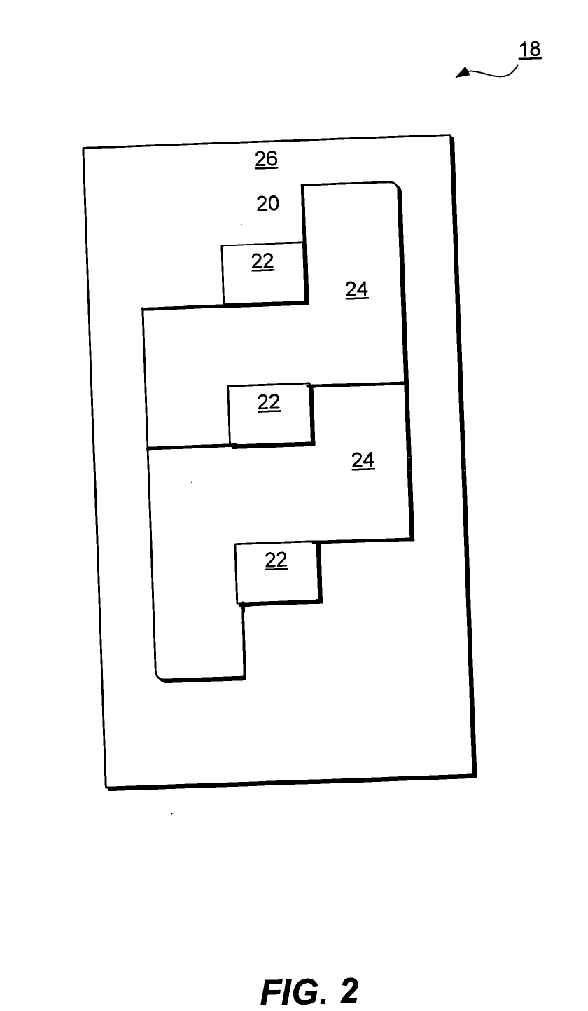

A fastening system 18 for attaching a wireless communication device is illustrated in FIGS. 2-5. The fastening system 18 enables incorporating potentially interfering materials (i.e., materials that might interfere with a mobile device's ability to send/receive communication signals and/or the device's wireless communication system) in the structural elements of the wireless mobile device without interfering with the mobile device's wireless communication system.

Enabling the potentially interfering materials to be incorporated in the mobile device's structural elements may enable making the device's more aesthetically appealing, among other benefits. The fastening system 18 may be described in the context of employing it in a watch assembly, although the fastening system 18 may be applied to other types of devices. The exemplary watch assembly is used for illustrative purposes only to simplify the following discussion, and may be used interchangeably with “wireless communication device.”

As discussed earlier, a wireless communication environment in which wireless communication devices are designed to operate in may often limit the types of materials used in their manufacture since some materials may interfere with the reception and/or transmission of wireless signals. For instance, in the case of a wristwatch with wireless communication capabilities, such as the smart watch 16 shown in FIG. 1, a metal linked band used in a watch assembly that has a communication system may potentially interfere with the watch's communication system.

One way to try to use the potentially interfering material to form a portion of the watch without causing interference may be to loop the antenna around the case. However, plastic watch cases may need to be used in this example because metal may shield the antenna from receiving a signal. Another way to try to use the potentially interfering material involves forming rectangular loops on either side of the watch band. However, metal may not be overlaid on the antennae and the watch band in this second example because the metal may span across the interior of the loop, shielding it from receiving radio frequency data.

Yet another way to try to use the potentially interfering material involves looping a watch's antenna around the wearer's wrist. This may allow overlaying metal over the watch band since the loop may be completed around the wrist. The metal or portions thereof may not span across the interior of the loop and therefore may not interfere with the watch communication system's ability to receive communication signals (e.g., RF signals). However, there are a few factors that may interfere with the watch communication system's ability to receive/send communication signals or data. The antenna material may need to be a minimum of 1 mm off the wearer's skin so that the wearer's wrist does not interfere with signals and the metal used to form the band should be insulated from the antenna material.

Generally, the fastening system 18 disclosed herein may use a conductive metal (e.g., copper) formed in a loop configure to form an antenna used by the watch's communication system, for example. Further, the looped metal may be molded into a plastic (e.g., polyurethane) band comprising cleats that may protrude out from the band, although the cleats may be arranged in other ways, other metals besides copper that may be used to receive/send signals may be used, the metal may be formed into other configurations besides loops, and other materials besides plastics may be used. The cleats may protect the watch's communication system (e.g., metal antenna loop) and may allow metal links to attach to it using traditional watch hardware.

The fastening system 18 may protect the antenna material by embedding it in a flexible plastic or polyurethane band that may have metal links applied to it. The fastening system 18 may comprise a connection between the polyurethane protected copper antenna loop and metal links while allowing for enough tolerance in the metal links so they can expand while arching around the Polyurethane band when wrapped or flexed around the watch wearer's wrist.

An example of the fastening system 18 is shown in FIGS. 2-5. The fastening system 18 shown in FIG. 2 may include one or more protrusions, such as cleats 22, which may be formed on a polyurethane band fastener 26, although other nonconductive, insulating and flexible materials may be used for the band fastener 26. FIG. 2 shows a top view of the fastener 26 with one or more cleats 22 coupled to one or more fastener cover links 24, for example.

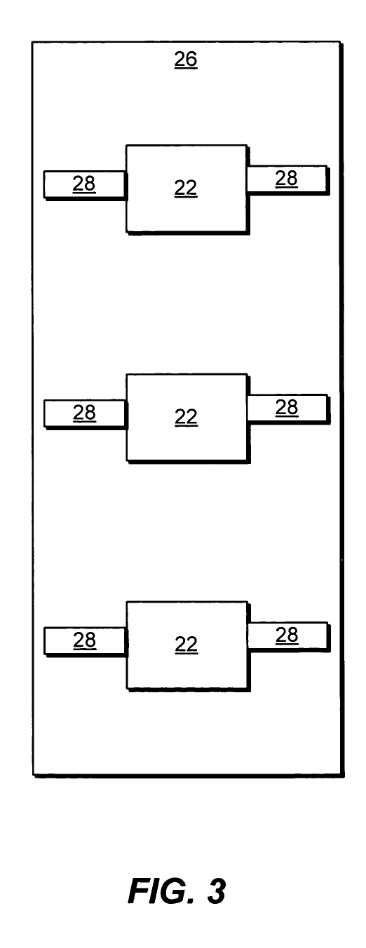

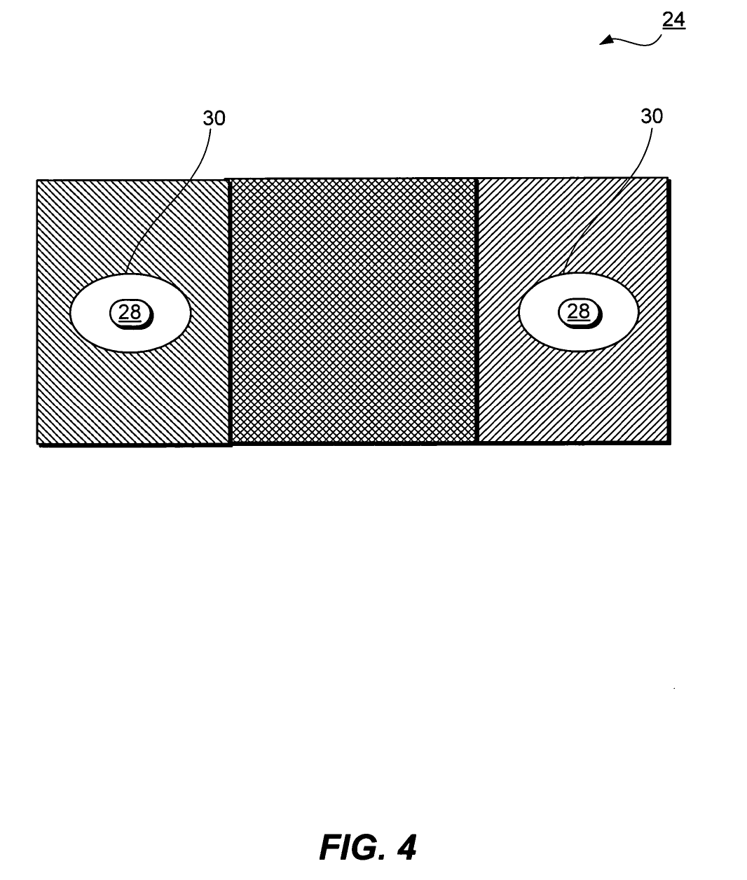

Referring specifically to FIG. 3, another top view of a portion of the fastening system 18 shown in FIG. 2 is shown without the one or more fastener cover links 24. As shown in FIG. 3, the one or more cleats 22 may include one or more connectors or pins 28. These connectors or pins 28 may engage one or more corresponding slots 30 formed in the cleats 24 as shown in FIGS. 3-4, although the connectors 28 may be formed in the fastener cover links 24 and the slots 30 may instead be formed in the cleats 22.

The slots 30 formed in the fastener cover links 24 may receive a connection pin 28 coupled to a cleat 22, although other configurations are possible, such as having a slot 30 formed in the cleat 22 for receiving a connection pin coupled to a link or having a slot formed in the cleat 22 and another slot formed in the link and having a connection pin inserted in both slots 30 of the cleat 22 and link to form a connection. The link 26 may be metal and the connection pin 28 may be any conductive material, such as metal (e.g., stainless steel), although other decorative conductive materials may be used.

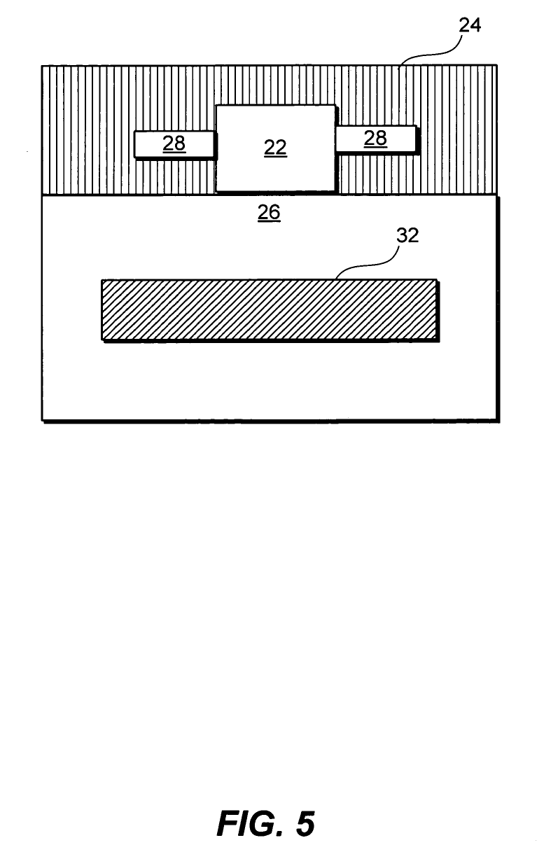

Further, the cleats 22 may protect a conductive material, such as an antenna loop 32 embedded within the fastener 26 as shown in FIG. 5. Further, the cleats 22 may allow metal fastener cover links 24 to attach to it, and hence the fastener 26, using traditional watch hardware, for instance. When the urethane band fastener 26 is bent, the fastener cover links 24 can slide in the slots 30 allowing the fastener cover links 24 to create a larger radius around the polyurethanes smaller radius expanding the fastener cover links 24 around the band fastener 26. The slots 30 in either of the cleat 22 and or link may allow for slack when bending around the wrist. Moreover, the slots 30 in the cleat 22 and inner portion of the fastener cover links 24 allow the fastener cover links 24 to expand when wrapped around the wrist.

Referring more specifically to FIGS. 4-5, a conductive material 32, such as copper, may be formed in a loop configuration and may be molded or embed into band fastener 26, which may include cleats 22 that may protrude out from the band fastener 26. The band fastener 26 may be made of any nonconductive or insulating material, such as a Polyurethane, although other insulating materials could be used.

As shown in FIG. 4, the fastener cover links 24 may be coupled to one another by the connection pins 28 that protrude through a slot 30 formed in the cleat 22 and/or the fastener cover links 24. A slot 30 may be used instead of a hole shaped opening to allow the fastener cover links 24, which may be inflexible depending on the material they are made from, to move a suitable amount of tolerance over the surface of the fastener so as to simulate bending or flexing over the band fastener 26 when wrapped around the wrist, for example, although other configurations may be used. Thus, the fastening system 18 may enable using a metal linked band fastener 26 (having a plastic or polyurethane buffer between the wrist and the fastener cover links 24) that may shields the watch's communication system (e.g., copper antenna) from interference from the fastener cover links 24 and wrist.

While particular examples and possible implementations have been called out above, alternatives, modifications, variations, improvements, and substantial equivalents that are or may be presently unforeseen may arise to applicants or others skilled in the art. Accordingly, the appended claims as filed, and as they may be amended, are intended to embrace all such alternatives, modifications, variations, improvements, and substantial equivalents. Further, the recited order of processing elements or sequences, or the use of numbers, letters, or other designations therefore, is not intended to limit the claimed process to any order except as may be specified in the claims.

What is claimed is:

1. At least one fastening system for coupling at least one wireless communication device to at least one object, the system comprising:
at least one fastener made of one or more non-conductive materials that couples the wireless communication device to the at least one object; and
one or more conductive materials embedded within a non-conductive portion of the at least one fastener that receive wireless communication signals to be processed by the wireless communication device.

2. The system of claim 1 further comprising:
at least one fastener covering made of one or more conductive materials coupled to the at least one fastener by at least one connector and covering at least a portion of the at least one fastener without making contact with the one or more conductive materials embedded within the non-conductive portion.

3. The system of claim 2, wherein the at least one fastener covering is made of stainless steel or any other decorative, conductive material.

4. The system of claim 2 further comprising:
at least one protrusion coupled to and extending away from the non-conductive portion of the at least one fastener having at least one opening formed therein for receiving at least one connector.

5. The system of claim 4 wherein the dimensions of the at least one opening are greater than the dimensions of the at least one connector for enabling the at least one connector to move a first amount of distance within the at least one opening when the at least one connector is positioned within at least a portion of the at least one opening.

6. The system of claim 4, wherein the at least one protrusion is formed on a first surface of the at least one fastener facing away from the one or more conductive materials embedded within the non-conductive portion of the at least one fastener.

7. The system of claim 4, wherein the at least one connector is fixedly attached to the at least one protrusion.

8. The system of claim 2 further comprising:
at least one opening formed in the at least one fastener covering for receiving at least one connector coupled to at least one protrusion extending away from the non-conductive portion of the at least one fastener.

9. The system of claim 2, wherein the at least one protrusion coupled to the non-conductive portion of the at least one fastener has at least one opening formed therein for receiving at least one connector.

10. The system of claim 8, wherein the at least one opening comprises an oval shaped or elongated slot.

11. The system of claim 2, wherein the non-conductive portion of the at least one fastener is made of polyurethane or any other non-conductive insulating material.

12. The system of claim 1, wherein the conductive material embedded within the non-conductive portion of the at least one fastener comprises a copper or any other material suitable for receiving the communication signals.

13. The system of claim 1, wherein the at least one object comprises a human being or any other living being.

14. The system of claim 1, wherein the wireless communication device comprises a wrist watch device that can receive and process wireless communication signals.

15. A method of manufacturing at least one fastening system for attaching at least one wireless communication device to at least one object, the method comprising:
forming one or more non-conductive materials into a fastener for coupling the wireless communication device to the at least one object; and
embedding one or more conductive materials that receive wireless communication signals to be processed by the wireless communication device within a non-conductive portion of the at least one fastener.

16. The method of claim 15 further comprising:
forming one or more conductive materials into at least one fastener covering; and
covering at least a portion of the at least one fastener without making contact with the one or more conductive materials embedded within the non-conductive portion.

17. The method of claim 16 wherein the at least one fastener covering is coupled the at least one fastener by at least one connector coupled to at least one protrusion formed on the non-conductive portion of the fastener.

18. The method of claim 16, wherein the at least one fastener covering is made of stainless steel or any other conductive material.

19. The method of claim 2 further comprising:
forming at least one protrusion on the non-conductive portion of the fastener and extending away from the at least one fastener.

20. At least one fastening system for coupling at least one wireless communication device to at least one object, the system comprising:
at least one fastener made of one or more non-conductive materials that couples the wireless communication device to the at least one object;
one or more conductive materials embedded within a non-conductive portion of the at least one fastener that receive wireless communication signals to be processed by the wireless communication device; and
at least one fastener covering made of one or more conductive materials coupled to the at least one fastener by at least one connector and covering at least a portion of the at least one fastener without making contact with the one or more conductive materials embedded within the non-conductive portion.
